(19) United States
(12) Patent Application Publication
(10) Pub. No.: US 2020/0248041 A1
(43) Pub. Date: Aug. 6, 2020

(54) ACTIVATOR FOR ACCELERATED ADHESION DEVELOPMENT

(71) Applicant: SIKA TECHNOLOGY AG, Baar (CH)

(72) Inventors: Claudia JUNG, Hamburg (DE); Martin DEMMIG, Quickborn (DE); Rita CANNAS, Dübendorf (CH)

(73) Assignee: SIKA TECHNOLOGY AG, Baar (CH)

(21) Appl. No.: 16/641,932

(22) PCT Filed: Sep. 18, 2018
(86) PCT No.: PCT/EP2018/075145

§ 371 Date: Feb. 25, 2020

(30) Foreign Application Priority Data
Sep. 26, 2017 (EP) 17193116.5

(51) Int. Cl. C09J 11/06; C09J 175/04; C09J 5/02; B32B 7/12

(52) U.S. Cl. CPC C09J 11/06; C09J 175/04; C09J 2475/00; B32B 7/12; C09J 5/02

(57) ABSTRACT

An activator composition having a) between 0.5% and 50% by weight of a catalyst K for crosslinking two-component adhesives which is liquid at 23° C., b) between 40% and 99.5% by weight of an organic solvent L, c) between 0% and 10% by weight of at least one silane S including at least one hydrolyzable silane group and preferably at least one functional group selected from mercapto, epoxy, amino, methacryloyl, vinyl and alkyl group. The activator composition is storage stable for at least one month. The activator composition is moreover active independently of the applied amount and may be applied in layers having a thickness such that the adhesive may be applied after not more than 30 seconds.

### TECHNICAL FIELD

The invention relates to the field of solvent-based activator compositions.

### PRIOR ART

Solvent-based activators, especially as adhesion promoter undercoats, have long been used to accelerate the buildup of adhesion of adhesives, sealants, coatings and coverings on the substrate. Such activators enable faster bonding or coating of substrates, with very rapid buildup of adhesion of the adhesive on the substrate, allowing the bond to be subjected to stress after only a short time without adhesive failure. This enables fast cycle times in industrial manufacture. The rapid evaporation of the solvents also assists rapid working and cycle times.

For the production of activators, catalysts that catalyze the curing of the sealant or adhesive are typically dissolved in solvents. On application, the solvent largely evaporates and the adhesive can be applied to the substrate surface thus pretreated. As a result of the high concentration of catalytically active sites on the bonding surface, this results in the desired rapid buildup of adhesion.

However, a disadvantage of many activator compositions known to date is that the solubility of such catalysts, usually metal complexes, in many preferred solvents is poor. This is because the choice of solvent is highly limited in many applications, since there exist process-related, tight specifications on volatility and concerns relating to the effect of the solvent on health. This gives rise to the unwanted effect that precipitation of the catalyst out of the solutions is observed after a short time. One way of countering this disadvantage is the use of emulsifiers or other solubility-improving additives. However, such additives make the composition costlier and can adversely affect adhesion.

It is likewise disadvantageous that many catalysts after the application of the activator composition form a solid interface between the substrate and the adhesive. The effect of this is often that, after a short time, even in the case of adhesives having good adhesion, adhesive failure occurs between the substrate and the layer formed from the activator composition.

Both the unwanted effects mentioned are additionally compounded in that, in many cases, a relatively high concentration of catalyst must be present in the activator composition in order to achieve the desired acceleration of the buildup of adhesion.

There is therefore a need for an activator composition that has good storage stability without precipitation of the catalyst and does not cause any adhesion problems through formation of catalyst deposits at the interface of substrate and adhesive. It is also desirable that the activator would display satisfactory activator action irrespective of the amount used and, for example, can be applied in very thin layers, which entails a time saving through shorter flash-off times and a cost saving through lower material consumption, or in very high application rates with thick layers, which entails better activator action.

### SUMMARY OF THE INVENTION

It is therefore an object of the present invention to provide a one-component, solvent-based activator composition which is storage-stable for at least one month, preferably at least 2 months, especially at least 4 months or longer, without showing precipitation of the catalyst. In addition, the activator composition is to be active irrespective of the amount applied and hence have such short flash-off times that the adhesive can be applied after a short time, for example after 30 seconds. In addition, the activator composition is to be able to accelerate a 2-component polyurethane adhesive with respect to buildup of adhesion on the bonding substrate in such a way that at least 15%, preferably at least 20%, of the tensile shear strength of the bond that can be attained after storage at room temperature for 24 h is already attained after not more than one hour after application of the adhesive and curing at room temperature, and the fracture profile should be just as cohesive after 1 h as after 24 h.

It has now been found that, surprisingly, an activator composition as claimed in claim 1 is able to achieve these objects.

Further aspects of the invention are the subject of further independent claims. Particularly preferred embodiments of the invention are the subject of the dependent claims.

### WAYS OF EXECUTING THE INVENTION

The present invention provides an activator composition comprising
a) between 0.5% and 50% by weight of a catalyst K which is liquid at 23° C. for the crosslinking of two-component adhesives,
b) between 40% and 99.5% by weight of an organic solvent L,
c) between 0% and 10% by weight of at least one silane S having at least one hydrolyzable silane group and preferably at least one functional group selected from mercapto, epoxy, amino, methacryloyl, vinyl and alkyl group,
characterized in that the catalyst K comprises a 1,3-ketoamidate complex of a metal and in that the solvent L is selected from the group of acetone, methyl ethyl ketone, methyl n-propyl ketone, diisobutyl ketone, methyl isobutyl ketone, methyl n-amyl ketone, methyl isoamyl ketone, acetylacetone, mesityl oxide, cyclohexanone, methylcyclohexanone, ethyl acetate, propyl acetate, isopropyl acetate, butyl acetate, n-butyl propionate, diethyl malonate, 1-methoxy-2-propyl acetate, 3-methoxy-n-butyl acetate, ethyl 3-ethoxypropionate, diisopropyl ether, diethyl ether, dibutyl ether, diethylene glycol diethyl ether, ethylene glycol diethyl ether, ethylene glycol monopropyl ether, ethylene glycol mono-2-ethylhexyl ether, ethylbenzene, toluene, xylene, heptane, octane, naphtha, white spirit, petroleum ether, benzine, methylene chloride, methanol, ethanol, isopropanol, and mixtures of these solvents.

In the present document substance names beginning with “poly” such as polyol or polyisocyanate refer to substances formally containing two or more of the eponymous functional groups per molecule.

In the present document the term “polymer” firstly encompasses a group of macromolecules that are chemically uniform but differ in the degree of polymerization, molar mass, and chain length, said group having been produced by a “poly” reaction (polymerization, polyaddition, polycondensation). The term secondly also encompasses derivatives of such a group of macromolecules from poly reactions, i.e. compounds that have been obtained by reactions, for example additions or substitutions, of functional groups on defined macromolecules and that may be chemically uniform or chemically nonuniform. The term further encompasses so-called prepolymers as well, i.e. reactive initial oligomeric adducts, the functional groups of which are involved in the construction of macromolecules.

The term “polyurethane polymer” encompasses all polymers produced according to the so-called diisocyanate polyaddition process. This also includes polymers that are virtually or completely free of urethane groups. Examples of polyurethane polymers are polyether polyurethanes, polyester polyurethanes, polyether polyureas, polyureas, polyester polyureas, polyisocyanurates and polycarbodiimides.

In the present document the term “silane” refers to compounds which on the one hand have at least one, typically two, three or four, alkoxy groups or acyloxy groups bonded directly to the silicon atom via Si—O bonds. The term “organosilane” refers to silanes which additionally comprise at least one, and sometimes two or three, organic radicals bonded directly to the silicon atom via an Si—C bond. Such silanes are also known to the person skilled in the art as organoalkoxysilanes or organoacyloxysilanes. Accordingly, “tetraalkoxysilanes” are not organosilanes according to this definition but belong to the silanes. Accordingly, the term “silane group” refers to the silicon-containing group bonded to the organic radical of the silane via the Si—C bond. The silanes, i.e. the alkoxy- or acyloxysilane groups thereof, have the property of undergoing hydrolysis upon contact with moisture. This forms organosilanols, i.e. organosilicon compounds containing one or more silanol groups (Si—OH groups) and, through subsequent condensation reactions, organosiloxanes, i.e. organosilicon compounds containing one or more siloxane groups (Si—O—Si groups).

The term “silane-functional” refers to compounds comprising silane groups. “Silane-functional polymers” are accordingly polymers comprising at least one silane group.

Silane-containing polymers are in particular silane-containing organic polymers which are typically, and particularly in this document, synonymously also described as “silane-functional polymers”, “silane-modified polymers” (SMP) or “silane-terminated polymers” (STP). The crosslinking thereof proceeds via the condensation of silanol groups to form siloxane bonds and is conventionally catalyzed by means of organotin compounds such as dialkyltin(IV) carboxylates in particular.

The term “silane-containing polyether” also encompasses organic silane-containing polymers which, in addition to polyether units, may also contain urethane groups, urea groups or thiourethane groups. Such silane-containing polyethers may also be referred to as “silane-containing polyurethanes”.

“Aminosilanes”, “hydroxysilanes” and “mercaptosilanes” refer to organosilanes whose organic radical comprises an amino group, hydroxyl group and mercapto group respectively. “Primary aminosilanes” refer to aminosilanes having a primary amino group, i.e. an NH₂ group bonded to an organic radical. “Secondary aminosilanes” refer to aminosilanes having a secondary amino group, i.e. an NH group bonded to two organic radicals.

A substance or composition is referred to as “storage-stable” or “storable” when it can be stored at room temperature in a suitable container over a prolonged period, typically over at least 3 months up to 6 months or more, without any change in its application or service properties to an extent relevant for service thereof, as a result of the storage. To estimate storage stability storage at elevated temperatures may be carried out, thus simulating lengthier storage at lower temperatures such as room temperature.

“Room temperature” refers to a temperature of about 23° C.

All industry standards mentioned in this document relate to the version valid at the date of first filing.

The terms “mass” and “weight” are used synonymously in this document. Thus a “percentage by weight” (% by weight) is a percentage mass fraction which unless otherwise stated relates to the mass (the weight) of the total composition or, depending on the context, of the entire molecule.

“Molecular weight” is understood in the present document to mean the molar mass (in grams per mole) of a molecule or part of a molecule, also referred to as a “radical”. “Average molecular weight” denotes the number-average Mₙ of an oligomeric or polymeric mixture of molecules or radicals which is typically determined by means of gel permeation chromatography (GPC) against a polystyrene standard.

A first essential constituent of the activator composition of the invention is between 0.5% and 50% by weight, preferably between 0.75% and 25% by weight, especially between 1% and 10% by weight, based on the overall composition, of a catalyst K which is liquid at 23° C. for the crosslinking of two-component adhesives. This catalyst K comprises a 1,3-ketoamidate complex of a metal.

It is essential to the invention that the catalyst K is liquid at 23° C. in the form of a pure substance or in the form of a residue after the solvent L has evaporated.

The choice of catalyst depends essentially on the adhesive with which the activator is used. The person skilled in the art in the field of two-component adhesives, for example polyurethane adhesives or adhesives based on silane-terminated polymers, knows which catalysts are effective and suitable for curing thereof.

The catalyst K comprises at least one metal catalyst with at least one 1,3-ketoamidate ligand. Suitable metal catalysts that are very well known to the person skilled in the art in the field of polyurethane chemistry for the reaction of hydroxyl groups with isocyanate groups or in the field of alkoxysilane chemistry for the reaction of alkoxysilanes and/or silanols are, for example, complexes of aluminum, bismuth, iron, zinc, zirconium or tin.

Suitable catalysts K are especially organotin(IV) compounds, compounds of iron(III), bismuth(III) or zirconium(IV), especially iron(III) complexes. The ligands of these complexes are especially selected from alkoxides, carboxylates, 1,3-diketonates, oxinate, 1,3-ketoesterates and 1,3-ketoamidates. However, at least one 1,3-ketoamidate ligand must be present.

Particular preference is given to complexes, especially iron(III) complexes, of the formula Fe(L)ₓ(Y)₃₋ₓ where x is 1, 2 or 3, Y is a singly negatively charged ligand, and L is a ligand of the formula (I)

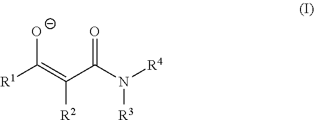

where R¹ and R² are independently a hydrogen radical, a monovalent saturated or unsaturated hydrocarbon radical having 1 to 10 carbon atoms, or together are a divalent alkylene radical having 3 to 6 carbon atoms, and R³ and R⁴ are independently a hydrogen radical, a monovalent saturated hydrocarbyl radical optionally containing heteroatoms and having 1 to 12 carbon atoms, or together are a divalent alkylene radical optionally containing heteroatoms and having 3 to 6 carbon atoms. The preparation of such complexes is described in EP2604617.

Preference is given to complexes, especially iron(III) complexes, of the formula Fe(L)₃ with three identical L ligands of the formula (I), where R¹ represents an alkyl radical having 1 to 4 carbon atoms or a phenyl radical, R² represents a hydrogen radical, and R³ and R⁴ represent an alkyl radical having 1-8 carbon atoms or an alkyl ether radical having 1-4 carbon atoms.

Very particular preference is given to complexes, especially iron(III) complexes, of the formula Fe(L)₃ with three identical ligands L of the formula (I), where R¹ is a methyl radical, R² is a hydrogen radical and R³ and R⁴ are each an ethyl radical, or R¹ is a methyl radical, R² is a hydrogen radical and R³ and R⁴ are an alkyl ether radical having 3 carbon atoms, or R¹ is a phenyl radical, R² is a hydrogen radical and R³ and R⁴ are a butyl radical, or R¹ is a butyl radical, R² is a hydrogen radical and R³ and R⁴ are a butyl radical.

Particularly preferred ligands for complexes as catalyst K are 1,3-ketoamidates, especially N,N-diethyl-3-oxobutanamidate, N,N-dibutyl-3-oxobutanamidate, N,N-bis(2-ethylhexyl)-3-oxobutanamidate, N,N-bis(2-methoxyethyl)-3-oxobutanamidate, N,N-dibutyl-3-oxoheptanamidate, N,N-bis(2-methoxyethyl)-3-oxoheptanamidate, N,N-bis(2-ethylhexyl)-2-oxocyclopentanecarboxamidate, N,N-dibutyl-3-oxo-3-phenylpropanamidate and N,N-bis(2-methoxyethyl)-3-oxo-3-phenylpropanamidate. These are more preferably used as Fe(III) complexes. Iron(III) ketoamidates have the advantage of being particularly heat-stable and of not being deactivated even under demanding temperature conditions, for example above 100° C. to 150° C.

Compounds suitable as catalyst K, in addition to the 1,3-ketoamidate complex, are nitrogen compounds such as, in particular, N-ethyldiisopropylamine, N,N,N′,N′-tetramethylalkylenediamines, polyoxyalkyleneamines, 1,4-diazabicyclo[2.2.2]octane; aminosilanes such as, in particular, 3-aminopropyltrimethoxysilane, 3-aminopropyldimethoxylmethylsilane, N-(2-aminoethyl)-3-aminopropyltrimethoxysilane, N-(2-aminoethyl)-3-aminopropylmethyldimethoxysilane, N-(2-aminoethyl)-N′-[3-(trimethoxysilyl)propyl]ethylenediamine and analogs thereof with ethoxy or isopropoxy groups instead of methoxy groups on the silicon; amidines such as, in particular, 1,8-diazabicyclo[5.4.0]undec-7-ene (DBU), 1,5-diazabicyclo[4.3.0]non-5-ene (DBN), 6-dibutylamino-1,8-diazabicyclo[5.4.0]undec-7-ene; guanidines such as, in particular, tetramethylguanidine, 2-guanidinobenzimidazole, acetylacetoneguanidine, 1,3-di-o-tolylguanidine, 2-tert-butyl-1,1,3,3-tetramethylguanidine; and imidazoles such as, in particular, N-(3-trimethoxysilylpropyl)-4,5-dihydroimidazole and N-(3-triethoxysilylpropyl)-4,5-dihydroimidazole.

Also especially suitable are combinations of different catalysts, in particular combinations of at least one metal catalyst and at least one nitrogen-containing compound.

In a preferred embodiment of the activator composition, the catalyst K comprises a complex of a metal selected from the group of Fe, Bi, Al, Zn and Zr and optionally additionally an organic compound selected from the group of tertiary amines, guanidines and amidines.

In a preferred embodiment of the activator composition, the catalyst K comprises a 1,3-ketoamidate complex of a metal, especially a Fe(III) 1,3-ketoamidate complex.

In a preferred embodiment of the activator composition, the activator composition is free of tin compounds. Such a composition is particularly user-friendly and environmentally friendly since tin compounds are of concern with regard to health and are demonstrably toxic in some cases.

In addition, the activator composition of the invention comprises between 40% and 99.5% by weight, preferably between 65% to 99% by weight, especially between 85% to 99% by weight, based on the overall composition, of an organic solvent L.

The solvent L is selected from the group of acetone, methyl ethyl ketone, methyl n-propyl ketone, diisobutyl ketone, methyl isobutyl ketone, methyl n-amyl ketone, methyl isoamyl ketone, acetylacetone, mesityl oxide, cyclohexanone, methylcyclohexanone, ethyl acetate, propyl acetate, isopropyl acetate, butyl acetate, n-butyl propionate, diethyl malonate, 1-methoxy-2-propyl acetate, 3-methoxy-n-butyl acetate, ethyl 3-ethoxypropionate, diisopropyl ether, diethyl ether, dibutyl ether, diethylene glycol diethyl ether, ethylene glycol diethyl ether, ethylene glycol monopropyl ether, ethylene glycol mono-2-ethylhexyl ether, ethylbenzene, toluene, xylene, heptane, octane, naphtha, white spirit, petroleum ether, benzine, especially Solvesso™ grades (from Exxon), methylene chloride, methanol, ethanol, isopropanol, and mixtures of these solvents.

Preferred embodiments of the activator composition according to the invention comprise a solvent L selected from the group of n-heptane, ethanol, isopropanol, methyl acetate, ethyl acetate, butyl acetate, isopropyl acetate, 1-methoxy-2-propyl acetate, 3-methoxy-n-butyl acetate, acetone, methyl ethyl ketone, methyl isobutyl ketone, toluene, ethylbenzene and mixtures thereof. Very particularly preferably, the solvent L is selected from the group of n-heptane, ethanol, isopropanol, ethyl acetate, methyl ethyl ketone, and mixtures thereof, where the solvent L most preferably comprises or consists of n-heptane and/or ethanol. A mixture of n-heptane and ethanol is particularly preferred since the activator composition is thus particularly storage stable and at the same time flashes off particularly rapidly.

In addition, the activator composition of the invention comprises between 0% and 10% by weight, preferably between 0.25% and 10% by weight, especially between 0.5% and 5% by weight, based on the overall composition, of at least one silane S having at least one hydrolyzable silane group, especially two silane groups, and preferably at least one functional group selected from mercapto, epoxy, amino, methacryloyl, vinyl and alkyl group.

The addition of at least one silane S has the advantage that a film adhering covalently or via other interactions is formed on the substrate surface, which improves the adhesion of the adhesive.

Suitable silanes S are firstly silanes having 4 hydrolyzable bonds on the silicon atom, for example tetraalkoxysilanes, e.g. tetramethoxysilanes, tetraethoxysilanes or other tetraalkoxysilanes, and the hydrolyzates, partial hydrolyzates or condensates thereof.

Also suitable and preferred as silanes S are organosilanes OS which, in addition to the hydrolyzable bonds on the silicon atom, have at least one nonhydrolyzable Si—C bond via which an organic radical is bonded to the silicon atom. The organic radical is especially a radical having a hydroxyl, mercapto, epoxy, amino, (meth)acryloyl, vinyl and/or alkyl group. In the case of the organosilanes OS too, it is possible to use the hydrolyzates, partial hydrolyzates or condensates thereof.

Preferred organosilanes OS include epoxysilanes such as, in particular, 3-glycidoxypropyltrimethoxysilane or 3-glycidoxypropyltriethoxysilane, hydroxysilanes, (meth)acryloylsilanes, anhydridosilanes, carbamatosilanes, vinylsilanes, alkylsilanes or iminosilanes, or oligomeric forms of these silanes.

Examples of suitable organosilanes OS are

octyltrimethoxysilane, dodecyltrimethoxysilane, hexadecyltrimethoxysilane, methyloctyldimethoxysilane;

3-glycidyloxypropyltrimethoxysilane, 3-glycidyloxypropyltriethoxysilane; 3-methacryloyloxypropyltrialkoxysilanes, 3-methacryloyloxypropyltriethoxysilane, 3-methacryloyloxypropyltrimethoxysilane;

3-aminopropyltrimethoxysilane, 3-aminopropyltriethoxysilane, 3-aminopropyldimethoxymethylsilane, 3-amino-2-methylpropyltrimethoxysilane, N-(2-aminoethyl)-3-aminopropyltrimethoxysilane, N-(2-aminoethyl)-3-aminopropyltriethoxysilane, N-(2-aminoethyl)-3-aminopropyldimethoxymethylsilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, [3-(2-aminoethylamino)propyl]trimethoxysilane (=4,7,10-triazadecyltrimethoxysilane), 2-aminoethyltrimethoxysilane, 2-aminoethyldimethoxymethylsilane, aminomethyltrimethoxysilane, aminomethyldimethoxymethylsilane, aminomethylmethoxydimethylsilane, 7-amino-4-oxaheptyldimethoxymethylsilane, N-(methyl)-3-aminopropyltrimethoxysilane, N-(n-butyl)-3-aminopropyltrimethoxysilane, bis[3-(trimethoxysilyl)propyl]amine and bis[3-(triethoxysilyl)propyl]amine;

3-mercaptopropyltriethoxysilane, 3-mercaptopropyltrimethoxysilane, 3-mercaptopropylmethyldimethoxysilane;

3-acylthiopropyltrimethoxysilane;

vinyltrimethoxysilane and vinyltriethoxysilane;

bis(3-trimethoxysilylpropyl)tetrasulfane, bis(3-methyldimethoxysilyl-propyl)tetrasulfane, bis(3-triethoxylsilylpropyl)tetrasulfane, bis(3-methyldiethoxysilylpropyl)tetrasulfane, bis(3-trimethoxysilylpropyl) disulfide, bis(3-methyldimethoxysilylpropyl) disulfide, bis(3-triethoxylsilylpropyl) disulfide and bis(3-methyldiethoxysilylpropyl)disulfides;

isocyanuratosilane compounds such as 1,3,5-N-tris(3-trimethoxysilylpropyl)isocyanuratosilane, 1,3,5-N-tris(3-methyldimethoxysilylpropyl)isocyanuratosilane, 1,3,5-N-tris(3-triethoxysilylpropyl)isocyanuratosilane, 1,3,5-N-tris(3-methyldiethoxysilylpropyl)isocyanuratosilane;

Also suitable are the recited organosilicon compounds whose alkoxy groups have been replaced by acetoxy groups, for example octyltriacetoxysilane (octyl-Si(O(O═C)CH₃)₃). Such organosilicon compounds eliminate acetic acid upon hydrolysis.

Likewise suitable are partial hydrolyzates, hydrolyzates and condensates of these recited silanes which are also commercially available as oligomeric organosiloxanes.

Suitable organosilanes OS further include the organosilicon compounds selected from the group comprising bis[3-(trimethoxysilyl)propyl]amine, bis[3-(triethoxysilyl)propyl]amine, 4,4,15,15-tetraethoxy-3,16-dioxa-8,9,10,11-tetrathia-4,15-disilaoctadecane (bis(triethoxysilylpropyl) polysulfide or bis(triethoxysilylpropyl)tetrasulfane), bis(triethoxysilylpropyl) disulfide.

Suitable organosilanes OS further include the organosilicon compounds selected from the group comprising tris[3-(trimethoxysilyl)propyl]amine, tris[3-(triethoxysilyl)propyl]amine, 1,3,5-tris[3-(trimethoxysilyl)propyl]-1,3,5-triazine-2,4,6(1H,3H,5H)-trioneurea (=tris(3-(trimethoxysilyl)propyl) isocyanurate) and 1,3,5-tris[3-(triethoxysilyl)propyl]-1,3,5-triazine-2,4,6(1H,3H,5H)-trioneurea (=tris(3-(triethoxysilyl)propyl) isocyanurate).

Preferred organosilanes OS are aminosilanes. Particular preference is given to 3-aminopropyltrimethoxysilane, N-(2-aminoethyl)-3-aminopropyltrimethoxysilane, bis[3-(trimethoxysilyl)propyl]amine, 3-aminopropyltriethoxysilane, N-(2-aminoethyl)-3-aminopropyltriethoxysilane and bis[3-(triethoxysilyl)propyl]amine and mixtures thereof with one another.

Likewise preferred as organosilanes OS are vinylsilanes, especially vinyltrimethoxysilane and vinyltriethoxysilane. These silanes are particularly inexpensive and nevertheless show a good effect.

Likewise preferred as organosilanes OS are methacryloylsilanes, especially 3-methacryloyloxypropyltrimethoxysilane.

In preferred embodiments, the activator composition of the invention comprises between 0.5% by weight and 10% by weight of silane S.

When silanes S are used in the activator composition of the invention, it may be advantageous to use a drying agent. This increases the storage stability of the composition by binding any water present and thus inhibiting the undesired hydrolysis of alkoxysilanes in the container.

Suitable drying agents include, for example, reactive silanes such as tetramethoxysilane, vinyltrimethoxysilane, α-functional silanes such as N-(silylmethyl)-O-methylcarbamates, especially N-(methyldiethoxysilylmethyl)-O-methylcarbamate, (methacryloxymethyl)silanes, ethoxymethylsilanes, N-phenyl-, N-cyclohexyl- and N-alkylsilanes, orthoformate esters, calcium oxide or molecular sieves and also isocyanates.

The amount of drying agent in the activator composition is between 0% and 3% by weight, preferably between 0.5% and 2% by weight, based on the overall composition.

A particularly preferred embodiment of the activator composition of the invention comprises
a) between 0.5% and 25% by weight, preferably between 0.5% and 10% by weight, of the catalyst K,
b) between 65% and 99.5%, preferably between 85% and 99% by weight, of the organic solvent L,
c) between 0% and 10% by weight, preferably between 0.5% and 5% by weight, of a silane S.

It may further be advantageous for the activator composition to comprise further additives. For example, it is additionally possible to use at least one organic film former. This may, for example, be an epoxy resin or poly(meth)acrylate.

The composition may additionally also include further constituents. More particularly, these are dyes, pigments, surfactants, emulsifiers, dyes, UV markers, fluorescence indicators, biocides, flame retardants and stabilizers, and other additives known to the person skilled in the art in the field of activators. An especially advantageous additive may be a UV marker. This is a substance which becomes visible under UV light. The use of such a substance has the advantage that, after the application of uncolored activator compositions, it is possible to check where precisely the composition has been applied and/or where the adhesive is to be applied.

In a further aspect, the present invention relates to the use of an activator composition as described above for acceleration of the buildup of adhesion of a two-component adhesive, preferably a two-component polyurethane adhesive.

The two-component adhesive used may in principle be any two-component adhesive that begins to cure after the two components have been mixed. The selection is guided by factors including the open time and the mechanical demands on the bond formed. It has been found that the activator composition of the invention is of especially good suitability for polyurethane adhesives, especially for polyurethane adhesives containing at least one polyurethane prepolymer having isocyanate groups. Such two-component polyurethane adhesives are widely commercially available, especially under the SikaForce® name from Sika Automotive GmbH, Germany. The activator composition is likewise of particularly good suitability for two-component silane-terminated (silane-functional) adhesives and two-component silicone adhesives.

In a further aspect, the present invention relates to a kit of parts comprising
a) an activator composition as described above,
b) a two-component adhesive as described above, preferably a two-component polyurethane adhesive.

In a further aspect, the present invention relates to a method of accelerating the buildup of adhesion on a substrate S1 in the bonding of the substrate S1 to a second substrate S2, comprising the steps of
i) applying an activator composition as described above to at least one of the substrates S1 and S2 to be bonded, preferably to both substrates S1 and S2;
ii) flashing off the activator composition applied;
iii) applying a two-component adhesive or sealant to the first substrate S1;
iv) contacting the adhesive or sealant with a second substrate S2; or
i) applying an activator composition as claimed in any of claims 1 to 8 to the first substrate S1 and/or the second substrate S2;
ii) flashing off the activator composition applied;
iii) applying a two-component adhesive or sealant to the second substrate S1;
iv) contacting the adhesive present on the second substrate S2 with the first substrate S1.

The flashoff time in step ii) is preferably not more than 30 seconds. The activator composition can be applied by means of a cloth, for example a cellulose fiber cloth. This results in a particularly thin layer of the activator composition that flashes off quickly. On the other hand, it can also be applied by means of a brush, cotton bud, felt or sponge. The result of this is that a greater amount is applied and hence there is a greater concentration of catalytically active particles on the substrate after the flashoff. The activator composition of the invention has the advantage that the activator effect is satisfactorily high essentially irrespective of the amount applied.

In a preferred embodiment of the method just described, the substrates S1 and S2 comprise a metal, a painted surface or a plastic.

In the same or another preferred embodiment of the method just described, the two-component adhesive is a polyurethane adhesive or an adhesive based on silane-functional polymers or a silicone adhesive.

In a further aspect, the present invention relates to an article, the production of which is performed by a method as just described.

The latter article is especially a mode of transport, especially an automobile, bus, truck, rail vehicle, ship or aircraft.

The substrate S1 may be identical or different to substrate S2.

Suitable substrates S1 or S2 are for example inorganic substrates such as glass, glass ceramic, concrete, mortar, brick, tile, gypsum and natural stones such as granite or marble; metals or alloys such as aluminum, steel, nonferrous metals, galvanized metals; organic substrates such as wood, plastics such as PVC, polycarbonates, PMMA, polyesters, epoxy resins; coated substrates such as powder-coated metals or alloys; and paints and lacquers. Especially preferred as substrates S1 or S2 are glass, glass ceramic, aluminum, electrocoated (dip-coated) surfaces and composite materials such as carbon fiber-reinforced plastic (CFP), glass fiber-reinforced plastic (GFP) and sheet molding compounds (SMCs).

The substrates can be pretreated if required prior to the application of the adhesive. Such pretreatments especially include physical and/or chemical cleaning processes, for example sanding, sandblasting, brushing or the like, or treating with detergents or solvents.

### EXAMPLES

The activator compositions that follow according to table 1 were produced by adding the catalyst K to the solvent L and stirring well under nitrogen. In all cases, n-heptane was used as solvent and one % by weight of catalyst K, based on the overall resulting composition, was added.

TABLE 1
Activator compositions prepared.

| | | Trade name | |
|---|---|---|---|
| | | (manufacturer) | |
| Activator | Catalyst K | of catalyst K | Comments |
| A-1 (Ref.) | Acetylacetonato-Fe(III) | Fe(acac)₃ | Soluble and |
| | | (Sigma | storage- |
| | | Aldrich) | stable |
| A-2 (Ref.) | Bi(III) carboxylate | K-Kat XK-651 | Soluble and |
| | | (King | storage- |
| | | Industries) | stable |
| A-3 (Ref.) | Dibutyltin dilaurate | Addocat 201 | Soluble and |
| | | (Lanxess) | storage- |
| | | | stable |
| A-4 | Fe(III) tris(N,N-diethyl-3- | (by method in | Soluble and |
| | oxobutanamidate) | EP2604617) | storage- |
| | | | stable |
| A-5 | Fe(III) tris(N,N-dibutyl-3- | (by method in | Soluble and |
| | oxoheptanamidate) | EP2604617) | storage- |
| | | | stable |
| A-6 | Fe(III) tris(N,N-dibutyl-3- | (by method in | Soluble and |
| | oxohexanamidate) | EP2604617) | storage- |
| | | | stable |
| A-7 (Ref.) | Dioctyltin dilaurate | TIB KAT | Soluble and |
| | | 216 (TIB | storage- |
| | | Chemicals) | stable |
| A-8 (Ref.) | Dioctyltin thioglycolate | Fomrez UL-29 | Slight |
| | | (Momentive) | precipitation |
| | | | after a |
| | | | couple |
| | | | of days |
| A-9 (Ref.) | Dimethyltin thioglycolate | Fomrez UL- | Slight |
| | | 54(Momentive) | precipitation |
| | | | after a |
| | | | couple |
| | | | of days |
| A-10 (Ref.) | 1,3,5-tris(3- | Jeffcat TR-90 | Soluble and |
| | (dimethylamino)propyl)- | (Huntsman) | storage- |
| | hexahydro-s-triazine | | stable |

The activator compositions in table 1 were placed into tightly sealable glass bottles and, after storage at room temperature for 1 day, used for the adhesion tests. The substrate used was plates coated by cathodic dip coating (from Rocholl, Germany).

Adhesion Test of Adhesion Promoter Compositions

The compositions were applied to the substrate by means of a cellulose cloth soaked therewith (Tela®, Tela-Kimberly Switzerland GmbH) or by means of a cotton bud. On application by cotton bud, distinctly more activator was applied to the bonding surface, such that running of the activator solution was visible. All substrates were cleaned immediately prior to application of the adhesion promoter composition by wiping using a cellulose cloth (Tela®) that had been soaked with isopropanol and flashed off for at least 2 minutes prior to the application of the adhesion promoter composition.

30 seconds after application of the adhesion promoter composition, SikaForce®-7666 L10 BT, a two-component polyurethane adhesive, was applied by means of expression cartridge and nozzle, so as to result in a bonding area of 15×45 mm and a layer thickness of 1.6 mm. SikaForce®-7666 L10 BT is a high-modulus, two-component polyurethane adhesive commercially available from Sika Automotive GmbH, Germany.

After a curing time of 1 hour, the adhesive was tested after storage in a climate-controlled room (‘1 h’) (23° C., 50% rel. air humidity), and after storage in a climate-controlled room for 24 h (‘24 h’).

The bonding of the adhesive was tested by means of a tensile shear strength test and analysis of the fracture profile. Tensile shear strength was tested here in accordance with ISO 4587/DIN EN 1465 on a Zwick/Roell Z010 tensile tester on the above-described mutually bonded cathodically electrocoated substrates (bonding area: 15×45 mm; layer thickness: 1.6 mm; measurement speed: 10 mm/min; temperature: 23° C.). All activators of the invention gave fully cohesive fracture profiles.

Adhesion was assessed via the fracture profile of the substrates pretreated with activator. What is desired is purely cohesive behavior.

All inventive compositions produced showed exceptional storage stability. Even after several months no precipitation or cloudiness was observable.

TABLE 2
Tensile shear strength of the test bonds.

| Application | |
|---|---|
| Cellulose cloth | Cotton bud |

Curing time

| | | | |
|---|---|---|---|
| 1 h RT | 24 h RT | 1 h RT | 24 h RT |

| | |
|---|---|
| Activator | Tensile shear strength [MPa] |

| | | | | |
|---|---|---|---|---|
| None (Ref.) | 1.63* | 7.80 | 1.63* | 7.80 |
| A-1 (Ref.) | 2.20 | 5.49 | 1.41* | 7.76 |
| A-2 (Ref.) | 1.24* | 6.56 | 0.59* | 4.31* |
| A-3 (Ref.) | 0.45* | 5.00* | 1.63 | 4.77* |
| A-4 | 1.37 | 8.44 | 1.71 | 7.89 |
| A-5 | 2.07 | 9.15 | 2.41 | 7.96 |
| A-6 | 2.34 | 8.77 | 2.42 | 8.32 |
| A-7 (Ref.) | 0.26* | 1.89* | 0.57* | 2.99* |
| A-8 (Ref.) | 0.65* | 7.63 | 0.75* | 5.45* |
| A-9 (Ref.) | 1.80 | 7.45 | 0.46* | 6.17 |
| A-10 (Ref.) | 1.61 | 4.07* | 0.62* | 6.76 |

*partial or complete adhesive failure of the bond.

In addition, tests were conducted with infrared (IR) curing. This involves coating a test sheet with the activator composition as described above for the bonds, clamping it into an IR device and preheating it from below. During that time, the adhesive was applied to the opposite side. After a defined heating phase, a second coated test sheet was clamped in and hence joined. The adhesive and the activator layer had a temperature of 105° C. Thereafter, the bond was stored under standard climatic conditions for 24 h. Of all activators A-1 to A-10, only A-4, A-5 and A-6 showed a completely cohesive fracture profile and the expected strengths irrespective of the amount of the activator applied.

1. An activator composition comprising
a) between 0.5% and 50% by weight of a catalyst K which is liquid at 23° C. for the crosslinking of two-component adhesives,
b) between 40% and 99.5% by weight of an organic solvent L,
c) between 0% and 10% by weight of at least one silane S having at least one hydrolyzable silane group and at least one functional group selected from mercapto, epoxy, amino, methacryloyl, vinyl and alkyl group,
wherein the catalyst K comprises a 1,3-ketoamidate complex of a metal, and in that the solvent L is selected from the group of acetone, methyl ethyl ketone, methyl n-propyl ketone, diisobutyl ketone, methyl isobutyl ketone, methyl n-amyl ketone, methyl isoamyl ketone, acetylacetone, mesityl oxide, cyclohexanone, methylcyclohexanone, ethyl acetate, propyl acetate, isopropyl acetate, butyl acetate, n-butyl propionate, diethyl malonate, 1-methoxy-2-propyl acetate, 3-methoxy-n-butyl acetate, ethyl 3-ethoxypropionate, diisopropyl ether, diethyl ether, dibutyl ether, diethylene glycol diethyl ether, ethylene glycol diethyl ether, ethylene glycol monopropyl ether, ethylene glycol mono-2-ethylhexyl ether, ethylbenzene, toluene, xylene, heptane, octane, naphtha, white spirit, petroleum ether, benzine, methylene chloride, methanol, ethanol, isopropanol, and mixtures of these solvents.

2. The activator composition as claimed in claim 1, wherein the solvent L is selected from the group of n-heptane, ethanol, isopropanol, methyl acetate, ethyl acetate, butyl acetate, isopropyl acetate, 1-methoxy-2-propyl acetate, 3-methoxy-n-butyl acetate, acetone, methyl ethyl ketone, methyl isobutyl ketone, toluene, ethylbenzene and mixtures thereof.

3. The activator composition as claimed in claim 2, wherein the solvent L is selected from the group of n-heptane, ethanol, isopropanol, ethyl acetate, methyl ethyl ketone, and mixtures thereof, where the solvent L comprises or consists of n-heptane and/or ethanol.

4. The activator composition as claimed in claim 1, wherein the catalyst K comprises a complex of a metal selected from the group of Fe, Bi, Al, Zn and Zr.

5. The activator composition as claimed in claim 4, wherein the catalyst K comprises an organic compound selected from the group of tertiary amines, guanidines and amidines.

6. The activator composition as claimed in claim 1, wherein the activator composition is free of tin compounds.

7. The activator composition as claimed in claim 1, wherein the activator composition comprises between 0.5% and 10% by weight of silane S.

8. The activator composition as claimed in claim 1, comprising
a) between 0.5% and 25% by weight of the catalyst K,
b) between 65% and 99.5% by weight of the organic solvent L,
c) between 0% and 10% by weight of a silane S.

9. A method of using an activator composition comprising obtaining the activator composition as claimed in claim 1, and accelerating the buildup of adhesion in a two-component adhesive using the activator composition.

10. A kit of parts comprising
c) an activator composition as claimed in claim 1,
d) a two-component adhesive.

11. A method of accelerating the buildup of adhesion on a substrate S1 in the bonding of the substrate S1 to a second substrate S2, comprising the steps of
i) applying an activator composition as claimed in claim 1 to at least one of the two substrates;
ii) flashing off the activator composition applied;
iii) applying a two-component adhesive or sealant to the first substrate S1;
iv) contacting the adhesive or sealant with a second substrate S2; or
i) applying an activator composition as claimed in claim 1 to at least one of the two substrates;
ii) flashing off the activator composition applied;
iii) applying a two-component adhesive or sealant to the second substrate S1;
iv) contacting the adhesive present on the second substrate S2 with the first substrate S1.

12. The method as claimed in claim 11, wherein at least one of the substrates S1 and S2 comprises a metal, a painted surface or a plastic.

13. The method as claimed in claim 11, wherein the two-component adhesive or sealant is a polyurethane adhesive or an adhesive based on silane-functional polymers.

14. An article produced by a method as claimed in claim 11.

15. The article as claimed in claim 14, wherein the article is a mode of transport.
